(19) United States
(12) Patent Application Publication
(10) Pub. No.: US 2023/0376871 A1
(43) Pub. Date: Nov. 23, 2023

(54) METHOD AND SYSTEM FOR OPERATING VEHICLE

(71) Applicant: Woven by Toyota, Inc., Tokyo (JP)

(72) Inventors: Koki MATSUSHITA, Bunkyo.ku (JP); Ryota NAKABAYASHI, Nagoya-shi (JP); Rika OIKE, Shizuoka-shi (JP); Motoaki UMAKOSHI, Nagoya-shi (JP)

(73) Assignee: Woven by Toyota, Inc., Tokyo (JP)

(21) Appl. No.: 18/321,162

(22) Filed: May 22, 2023

(30) Foreign Application Priority Data
May 23, 2022 (JP) 2022-083877

(51) Int. Cl. G06Q 10/0631; G06Q 10/047; G08G 1/00

(52) U.S. Cl. CPC G06Q 10/06315; G06Q 10/047; G08G 1/202

(57) ABSTRACT

The method of the present disclosure is a method for operating a regular service vehicle and an on-demand vehicle that travel by autonomous driving on a single lane having a plurality of overtaking places including a stop. According to the method, it is predicted that the on-demand vehicle is prevented from arriving at a location of a user of the on-demand vehicle at an optimal time by the regular service vehicle. When a passenger is on the regular service vehicle, an arrival time of the on-demand vehicle at the location of the user is delayed from the optimal time to cause the regular service vehicle to travel according to a regular operation schedule. When no passenger is on the regular service vehicle, the regular service vehicle is delayed from the regular operation schedule to cause the on-demand vehicle to arrive at the location of the user at the optimal time.

### CROSS-REFERENCE TO RELATED APPLICATION

The present application claims priority under 35 U.S.C. § 119 to Japanese Patent Application No. 2022-083877, filed May 23, 2022, the contents of which application are incorporated herein by reference in their entirety.

### BACKGROUND

### Field

The present disclosure relates to a method and a system for operating a regular service vehicle and an on-demand vehicle that travel by autonomous driving in a single lane.

### Background Art

JP2020-004404A discloses a prior art relating to the operation of two different types of vehicles. JP2020-004404A discloses a system for assigning a commuter vehicle (CV) to passengers in a multi-mode transportation network having CVs and fixed-schedule vehicles. The system determines a group of passengers based on travel requests from passengers and formulates an optimization problem that determines a departure time of each of the fixed schedule vehicles and the CVs. The system then generates CV assignment routes, etc., based on the solution defined by solving the optimization problem.

In addition to JP2020-004404A, JP2004-234469A and JP2002-208091A can be exemplified as documents showing the technical level of the technical field related to the present disclosure.

### SUMMARY

It has been studied to use the site of a track of a single railway line as a single lane. In addition, in areas where land is limited in the first place, it may be possible to secure only a single lane even if a lane is built. On the other hand, at present, mobility-as-a-service using vehicles traveling by autonomous driving has been studied in various fields. Autonomous driving vehicles for mobility-as-a-service include regular service vehicles that are operated in accordance with a regular operation schedule and on-demand vehicles that are operated in accordance with requests from users.

When mobility-as-a-service is more generally developed in society, it is assumed that there will be a need to operate the two types of mobility-as-a-service vehicles on a single lane. However, none of the prior art documents listed above discloses a method for operating a regular service vehicle and an on-demand vehicle that travels by autonomous driving on a single lane.

The present disclosure has been made in view of the above-described problems. It is an object of the present disclosure to provide a technique capable of operating a regular service vehicle and an on-demand vehicle that travel on a single lane by autonomous driving so as to achieve convenience for users of both the regular service vehicle and the on-demand vehicle.

In order to achieve the above objective, the present disclosure provides a vehicle operation method and a vehicle operation system as a vehicle operation technique.

The vehicle operation method of the present disclosure is a method for operating a regular service vehicle and an on-demand vehicle that travel by autonomous driving on a single lane having a plurality of overtaking places including a stop The vehicle operation method of the present disclosure predicts the on-demand vehicle being prevented from arriving at a user of the on-demand vehicle at an optimal time by the regular service vehicle, and performs the following according to the presence or absence of a passenger on the regular service vehicle. When a passenger is on the regular service vehicle, the vehicle operation method of the present disclosure delays an arrival time of the on-demand vehicle at the location of the user from the optimal time to cause the regular service vehicle to travel according to a regular operation schedule When no passenger is on the regular service vehicle, the vehicle operation method of the present disclosure delays the regular service vehicle from the regular operation schedule to cause the on-demand vehicle to arrive at the location of the user at the optimal time

A vehicle operation system of the present disclosure is a system for operating a regular service vehicle and an on-demand vehicle that travel by autonomous driving on a single lane having a plurality of overtaking places including a stop. The vehicle operation system of the present disclosure comprises at least one processor and a program memory coupled to the at least one processor and storing a plurality of executable instructions. The plurality of executable instructions cause the at least one processor to perform the following processes. The first process is to predict the on-demand vehicle being prevented from arriving at a user of the on-demand vehicle at an optimal time by the regular service vehicle. The second process is a process executed when a passenger is on the regular service vehicle, and is a process of delaying an arrival time of the on-demand vehicle at the location of the user from the optimal time to cause the regular service vehicle to travel according to a regular operation schedule. The second process is a process executed when no passenger is on the regular service vehicle, and is a process of delaying the regular service vehicle from the regular operation schedule to cause the on-demand vehicle to arrive at the location of the user at the optimal time.

According to the vehicle operation technique of the present disclosure, even if it is predicted that the on-demand vehicle is prevented from arriving at the location of the user of the on-demand vehicle at the optimal time by the regular service vehicle, when a passenger is on the regular service vehicle, the regular service vehicle is caused to travel according to the regular operation schedule. However, when no passenger is on the regular service vehicle, the on-demand vehicle is caused to arrive at the location of the user at the optimal time even if the regular service vehicle is delayed from the regular operation schedule. As described above, by changing the operation schedule of the regular service vehicle according to the presence or absence of the passenger of the regular service vehicle, it is possible to improve convenience for the user of the on-demand vehicle while giving priority to the passenger of the regular service vehicle.

In the vehicle operation technique of the present disclosure, when no passenger is on the regular service vehicle, the regular service vehicle mat be caused to pass through a no-passenger stop among stops at which the regular service vehicle is scheduled to stop in the regular operation schedule. The time corresponding to the delay from the regular operation schedule can be recovered by causing the regular service vehicle to pass through instead of stopping at the no-passenger stop.

In the vehicle operation technique of the present disclosure, the on-demand vehicle may be caused to travel so as to face the regular service vehicle. In this case, when a passenger is on the regular service vehicle, the on-demand vehicle may be caused to pass the regular service vehicle at a stop located in the direction opposite to the traveling direction of the on-demand vehicle with respect to a pick-up point where the on-demand vehicle picks up the user. On the other hand, when no passenger is on the regular service vehicle, the regular service vehicle may be caused to wait at an overtaking place located in the traveling direction of the on-demand vehicle with respect to the pick-up point until the on-demand vehicle passes through the overtaking place. The overtaking place where the regular service vehicle is caused to wait includes a stop.

In the vehicle operation technique of the present disclosure, the on-demand vehicle may be caused to travel so as to overtake the regular service vehicle. In this case, when a passenger is on the regular service vehicle, the on-demand vehicle may be caused to overtake the regular service vehicle at a stop located in the traveling direction of the on-demand vehicle with respect to a pick-up point where the on-demand vehicle picks up the user. On the other hand, when no passenger is on the regular service vehicle, the regular service vehicle may be caused to wait at an overtaking place located in the direction opposite to the traveling direction of the on-demand vehicle with respect to the pick-up point until the on-demand vehicle passes through the overtaking place. The overtaking place where the regular service vehicle is caused to wait includes a stop.

In the vehicle operation technique of the present disclosure, the optimal time at which the on-demand vehicle arrives may be the earliest time at which the on-demand vehicle is dispatched to the user on an assumption that there is no other vehicle in the single lane, or may be a designated time of dispatching the on-demand vehicle to the user.

As described above, according to the vehicle operation technique of the present disclosure, it is possible to improve convenience for the user of the on-demand vehicle while prioritizing the passenger of the regular service vehicle by changing the operation of the regular service vehicle in accordance with the presence or absence of the passenger of the regular service vehicle.

### BRIEF DESCRIPTION OF THE DRAWINGS

FIG. 1 is a diagram illustrating an outline of a vehicle operation system according to an embodiment of the present disclosure.

FIG. 2 is a block diagram illustrating a configuration of the vehicle operation system according to an embodiment of the present disclosure.

FIG. 3 is a diagram illustrating a first example of a vehicle operation method according to an embodiment of the present disclosure.

FIG. 4 is a diagram illustrating the first example of the vehicle operation method according to an embodiment of the present disclosure.

FIG. 5 is a diagram illustrating a second example of the vehicle operation method according to an embodiment of the present disclosure.

FIG. 6 is a diagram illustrating the second example of the vehicle operation method according to the embodiment of the present disclosure.

FIG. 7 is a diagram illustrating a third example of the vehicle operation method according to an embodiment of the present disclosure.

FIG. 8 is a diagram illustrating the third example of the vehicle operation method according to the embodiment of the present disclosure.

FIG. 9 is a diagram illustrating a fourth example of the vehicle operation method according to the embodiment of the present disclosure.

FIG. 10 is a diagram illustrating the fourth example of the vehicle operation method according to the embodiment of the present disclosure.

### DETAILED DESCRIPTION

### 1. Outline of Vehicle Operation System

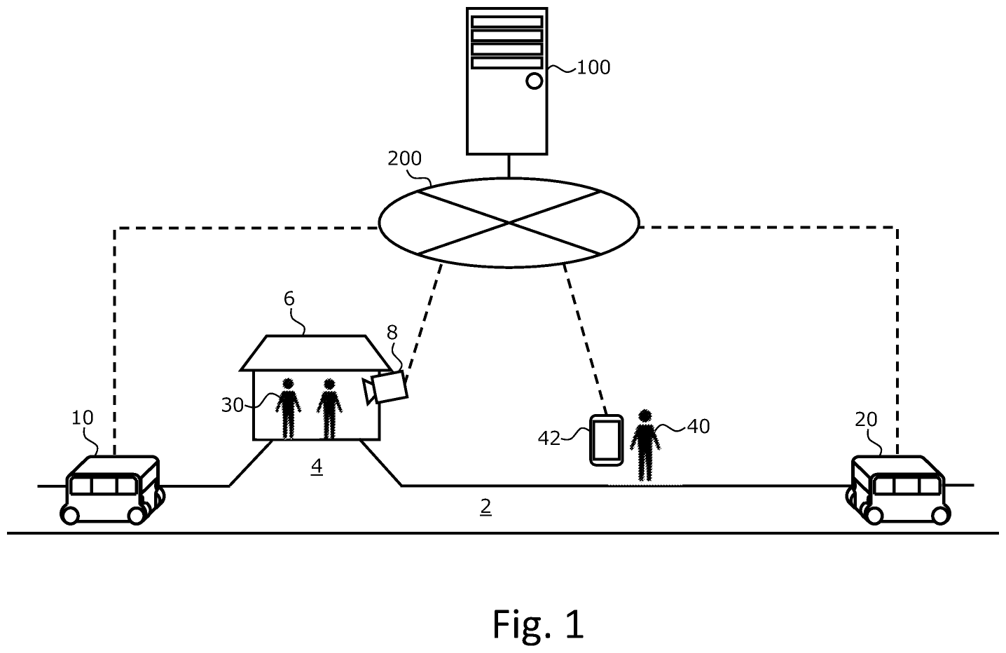

FIG. 1 is a diagram illustrating an outline of a vehicle operation system according to an embodiment of the present disclosure. The operation system is a system for operating vehicles 10 and 20 on a single-lane line 2. The single-lane line 2 is, for example, a line built on the site of a single railway line. On the single-lane line 2, two vehicles 10 and 20 cannot travel side by side or pass by each other. For this reason, the single-lane line 2 is provided with a plurality of overtaking places for allowing vehicles 10 and 20 to overtake each other and pass each other.

The overtaking place includes at least one stop 4. If the single-lane line 2 is built on the site of a single railway line, the stop 4 corresponds to a railway station. Even in the case of a single railway line, the station is constructed so that a train traveling on the forward path and a train travelling on the return path can pass each other. Thus, the stop 4 diverted from the station allows two vehicles 10 and 20 to pass each other and overtake each other. A waiting house 6 is set up at the stop 4 as a waiting place for a user 30. The waiting place 6 is provided with a camera 8 for photographing the state of the inside. The overtaking places other than the stop 4 provided in the single-lane line 2 are places for only passing and overtaking for vehicles 10 and 20, and the waiting house 6 is not provided.

The vehicles 10 and 20 operated by the operation system are a regular service vehicle 10 and an on-demand vehicle 20. The regular service vehicle 10 is a vehicle that is regularly operated in accordance with a regular operation schedule. The on-demand vehicle 20 is a vehicle that does not have a fixed operation schedule and is operated in response to a request from a user. In the operation system, autonomous driving vehicles that travel by autonomous driving are used as the regular service vehicle 10 and the on-demand vehicle 20.

Management of operation of the regular service vehicle 10 which is an autonomous driving vehicle is performed by an operation management server 100. In addition, management of operation of the on-demand vehicle 20 which is an autonomous driving vehicle is also performed by the operation management server 100. The regular service vehicle 10 and the on-demand vehicle 20 are connected to the operation management server 100 via a network 200.

Both the regular service vehicle 10 and the on-demand vehicle 20 may be an electric vehicle, an engine vehicle, or a hybrid vehicle. The electric vehicle mentioned here includes not only a vehicle equipped with a battery or a fuel cell but also a vehicle that takes in electricity from a pantograph, such as an electric train. Further, both vehicles 10 and 20 are not limited to vehicles with tires, and may be vehicles traveling on tracks such as trains. In this case, the regular service vehicle 10 may be an automatically driven train such as a streetcar in a city, and the on-demand vehicle 20 may be an autonomously driven automobile.

The user 30 is a user who uses the regular service vehicle 10. The user 30 boards the regular service vehicle 10 from the stop 4. The regular service vehicle 10 stops at the stop 4 according to the regular operation schedule. The user 30 waiting for the regular service vehicle 10 at the stop 4 is photographed by the camera 8. The image captured by the camera 8 is transmitted to the operation management server 100 via the network 200. The operation management server 100 detects the user 30 waiting for the regular service vehicle 10 from the image captured by the camera 8. When a gate using an IC card is provided in the waiting place 6, the user 30 entering the waiting place 6 may be detected based on information from the gate.

The user 40 is a user who uses the on-demand vehicle 20. The user 40 can call the on-demand vehicle 20 not only at the stop 4 but also anywhere near the single-lane line 2. The user 40 reserves dispatch of the on-demand vehicle 20 using a mobile terminal 42 represented by a smartphone. The reservation for dispatching the on-demand vehicle 20 is made to the operation management server 100. The operation management server 100 specifies a place where the user 40 waits using the position information of the mobile terminal 42.

### 2. Configuration of Vehicle Operation System

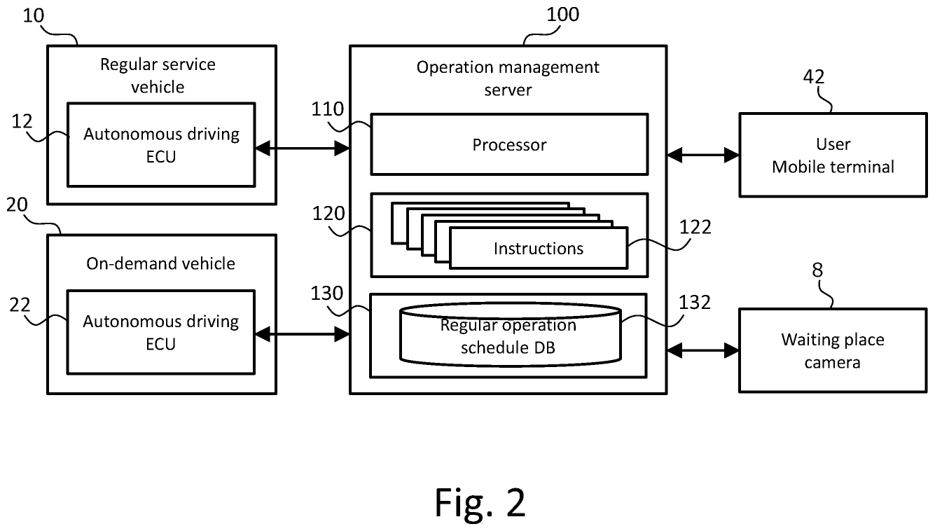

FIG. 2 is a block diagram illustrating a configuration of the vehicle operation system according to an embodiment of the present disclosure. The operation system includes the operation management server 100. The operation management server 100 includes at least one processor (hereinafter simply referred to as a processor) 110, a program memory 120, and a storage 130. The processor 110 is coupled to the program memory 120 and the storage 130. The program memory 120 may be a non-transitory memory that stores executable instructions 122. The storage 130 is, for example, a flash memory, an SSD, or an HDD, and stores a regular operation schedule database 132.

The operation management server 100 communicates with an autonomous driving ECU 12 of the regular service vehicle 10 and transmits instructions including the operation schedule of the regular service vehicle 10 to the autonomous driving ECU 12. Information regarding the presence or absence of passengers in the regular service vehicle 10 is transmitted from the autonomous driving ECU 12 to the operation management server 100. The presence or absence of passengers can be determined by a method of detecting passengers by an in-vehicle camera, a method of counting the number of getting-on persons and the number of getting-off persons by a sensor installed at a door, or the like. The operation schedule of the regular service vehicle 10 is determined based on predetermined reference information on the basis of the regular operation schedule registered in the regular operation schedule database 132. The predetermined reference information includes the dispatch request of the user 40 of the on-demand vehicle 20, the presence or absence of passengers in the regular service vehicle 10, and the presence or absence of the user 30 waiting at the waiting place 6. These processes are executed by the operation management server 100 when predetermined instructions 122 are executed by the processor 110.

The operation management server 100 communicates with an autonomous driving ECU 22 of the on-demand vehicle 20 and transmits instructions including the operation schedule of the on-demand vehicles 20 to the autonomous driving ECU 22. The operation schedule of the on-demand vehicle 20 is determined with reference to the regular operation schedule registered in the regular operation schedule database 132 based on a dispatch request for the on-demand vehicle 20 from the user 40. These processes are executed by the operation management server 100 when predetermined instructions 122 are executed by the processor 110.

The operation management server 100 communicates with the mobile terminal 42 of the user 40. The operation management server 100 receives, from the portable terminal 42, a dispatch request for reserving the dispatch of the on-demand vehicle 20 from the user 40 and position information of the user 40. The operation management server 100 transmits, to the mobile terminal 42, a notification for notifying completion of reservation of dispatching the on-demand vehicle 20 and position information for notifying a position where the on-demand vehicle 20 is currently traveling. These processes are executed by the operation management server 100 when predetermined instructions 122 are executed by the processor 110.

The operation management server 100 communicates with the camera 8 in the waiting place 6. The operation management server 100 determines the presence or absence of the user 30 waiting at the waiting place 6 from the image captured by the camera 8. The presence or absence of the user 30 waiting at the waiting place 6 is used as information for determining the operation schedule of the regular service vehicle 10. These processes are executed by the operation management server 100 when predetermined instructions 122 are executed by the processor 110.

In the next section, the vehicle operation method executed by the operation management server 100 will be described using specific examples.

### 3. Method of Operating Vehicle

### 3-1. Premise

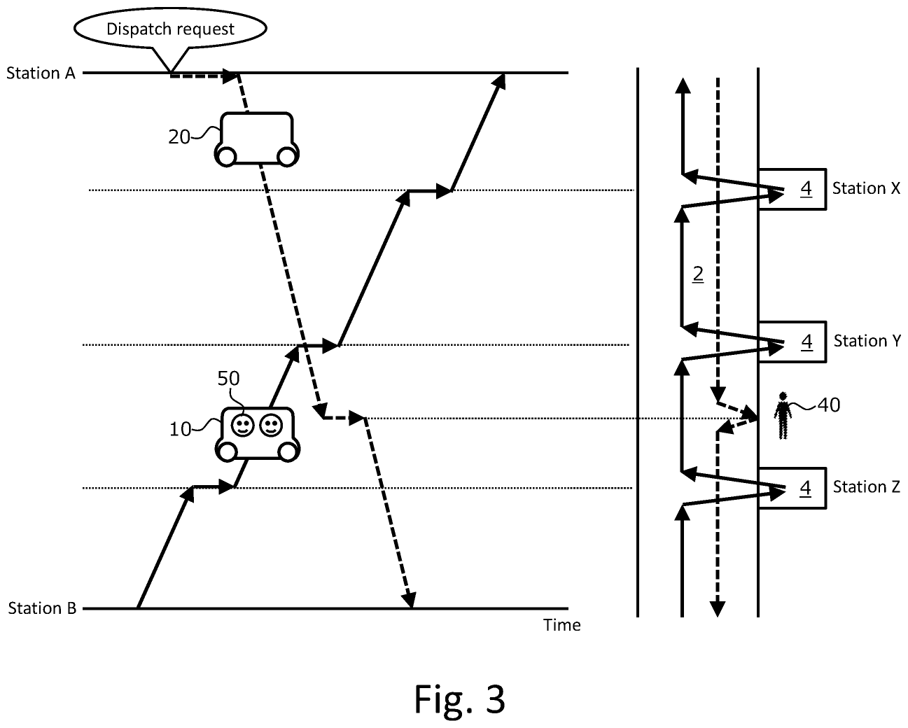

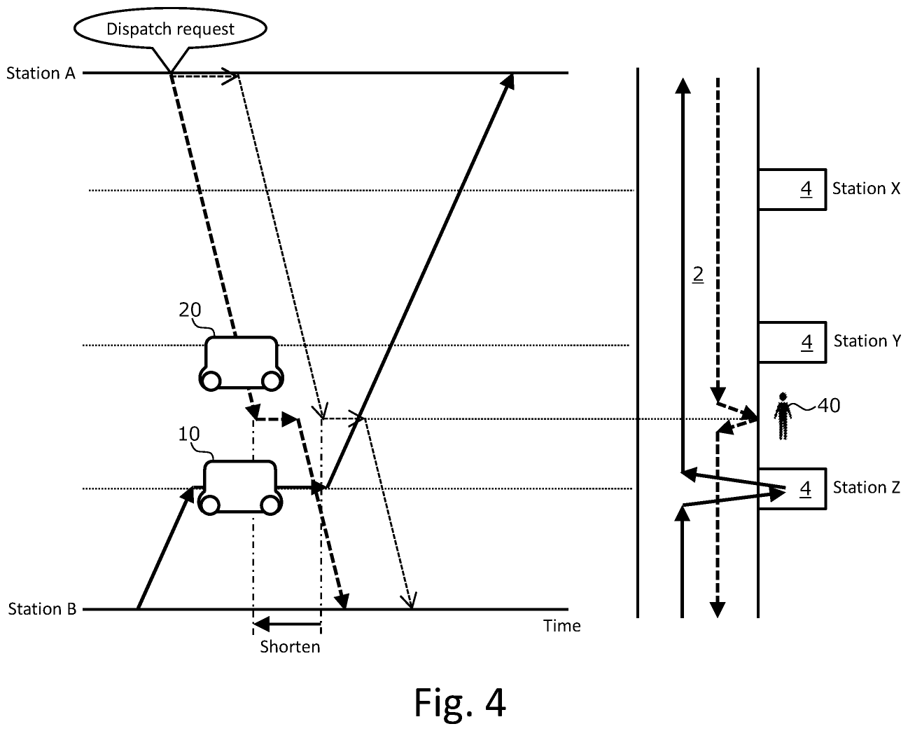

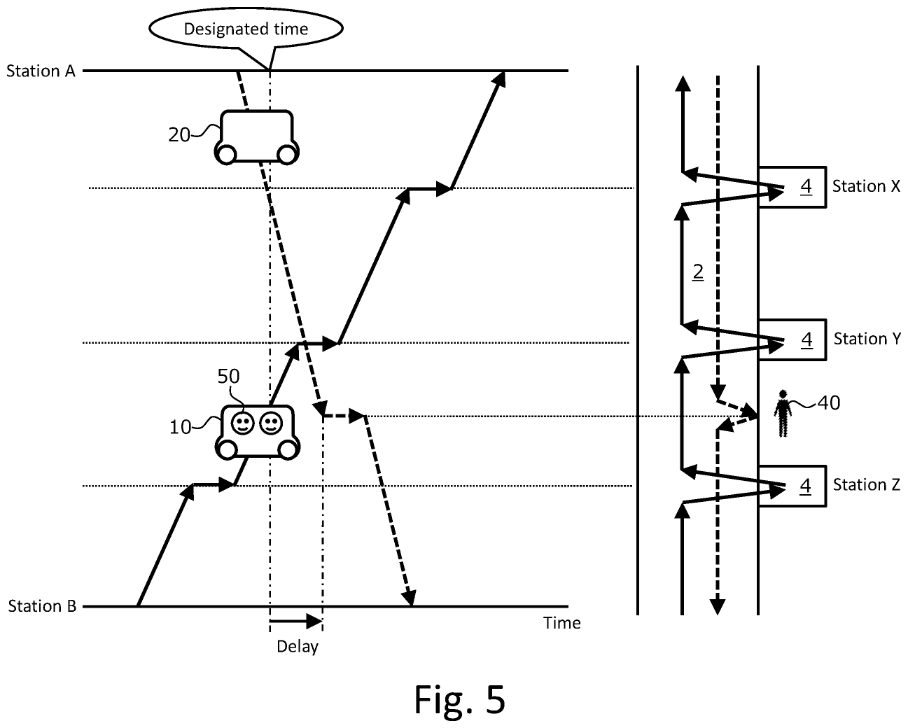

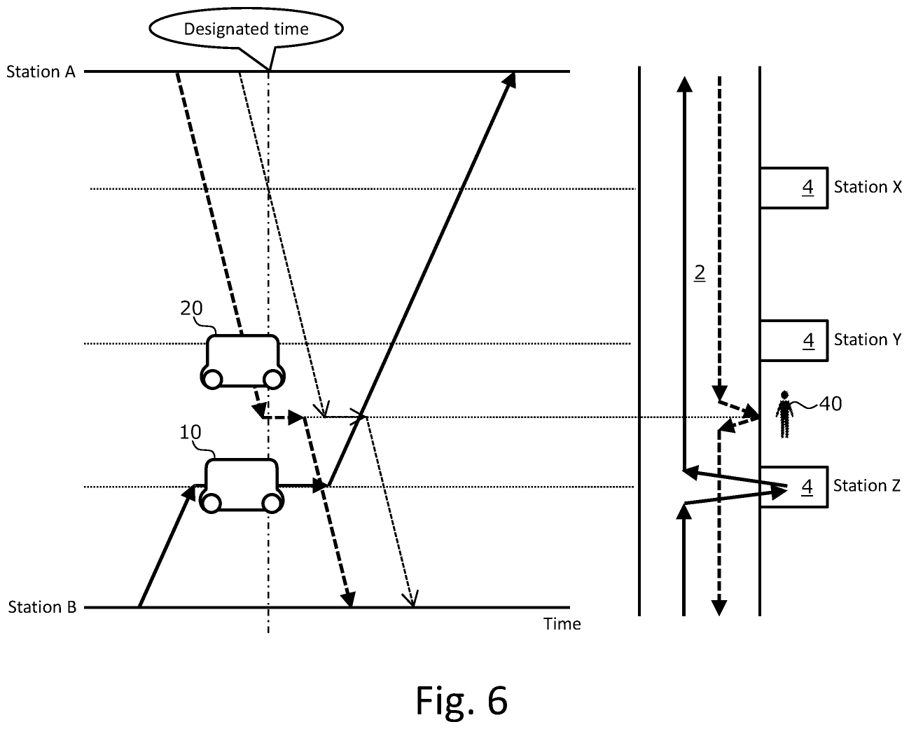

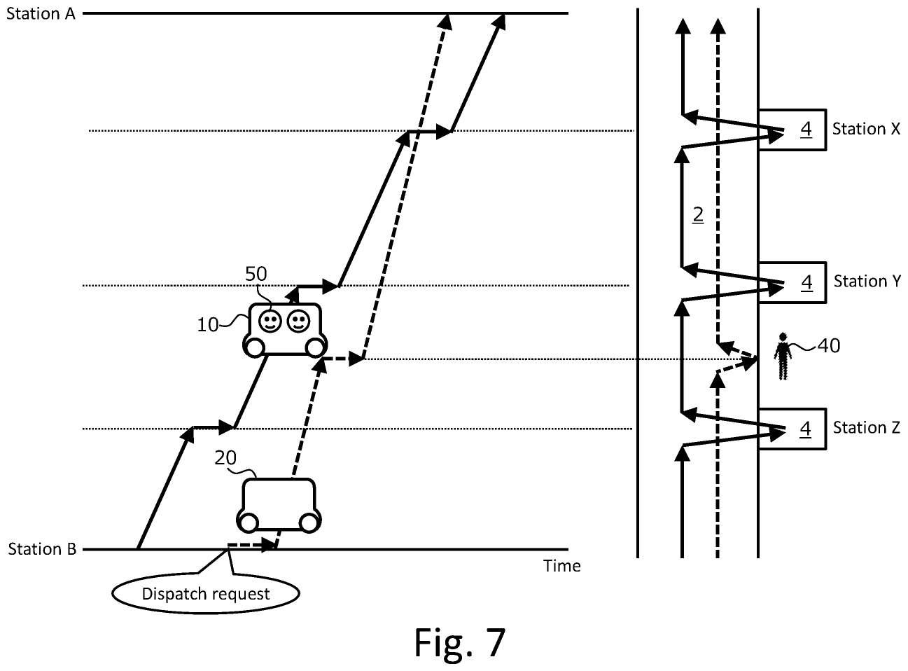

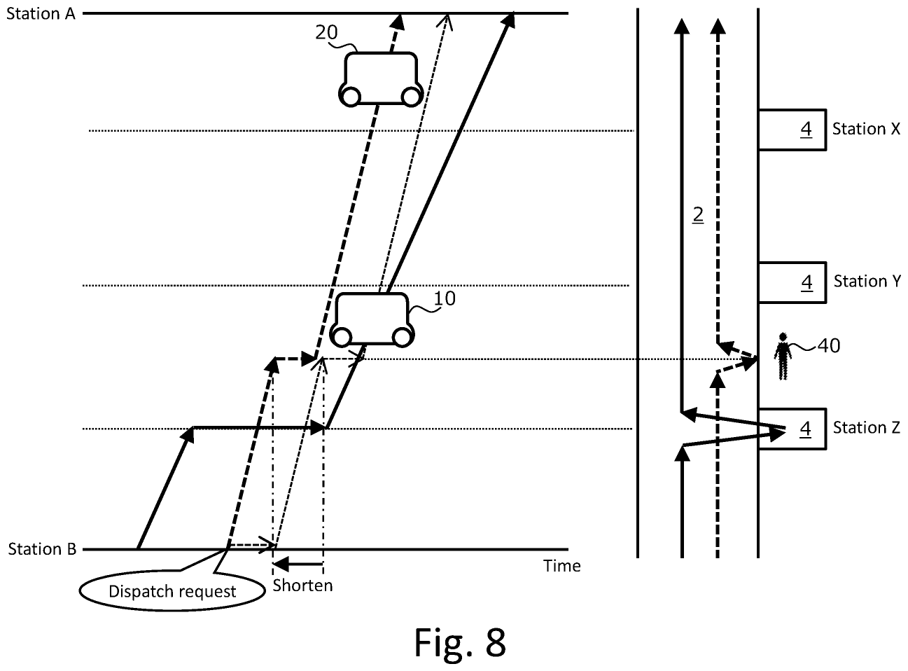

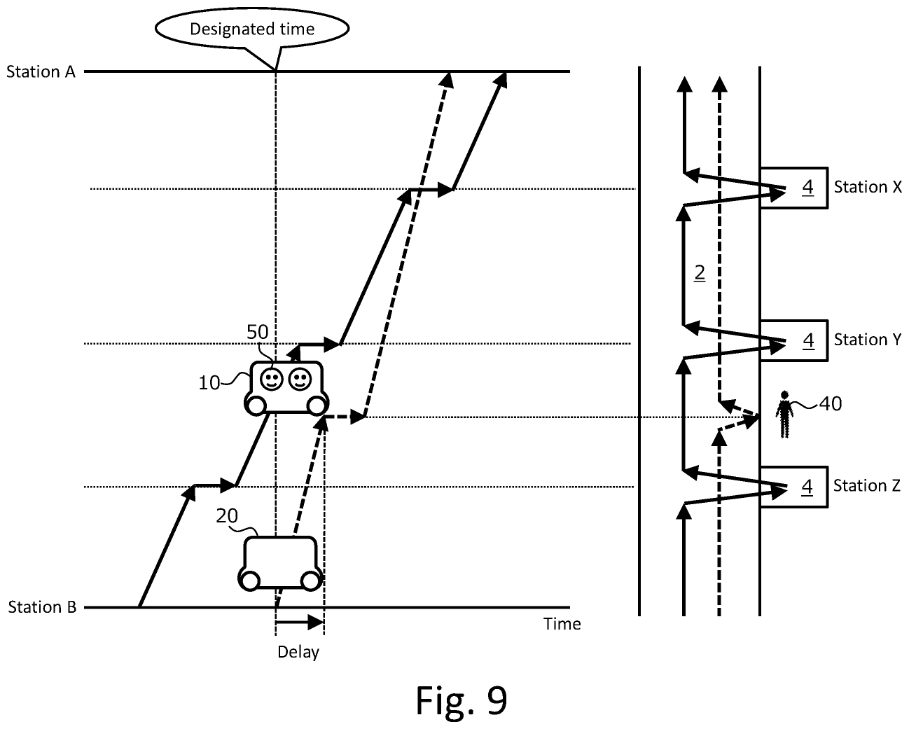

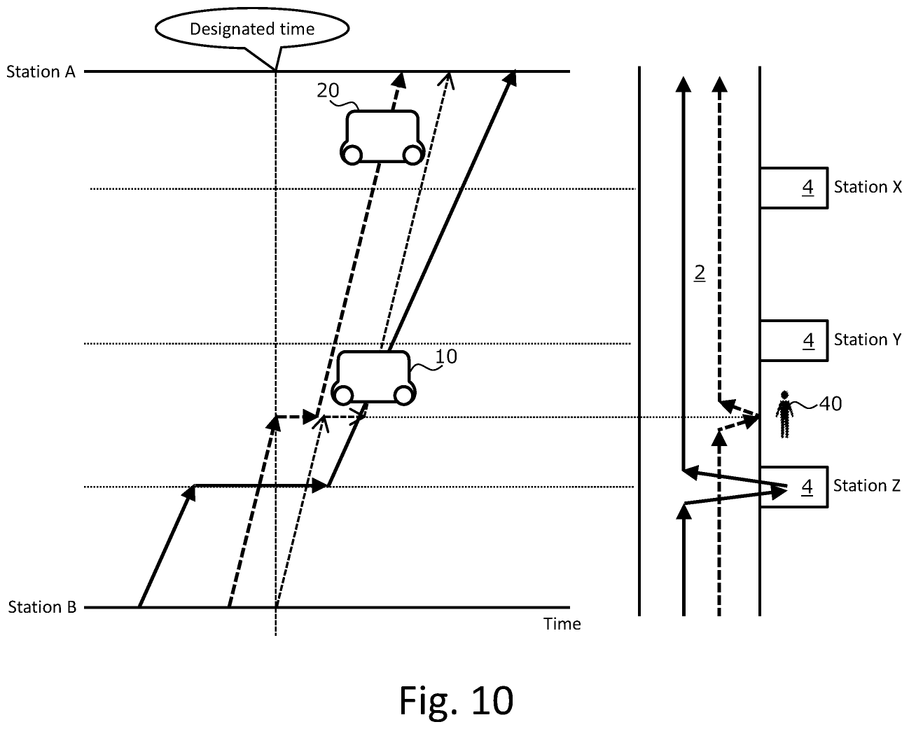

FIGS. 3 and 4 are diagrams illustrating a first example of the vehicle operation method. FIGS. 5 and 6 are diagrams illustrating a second example of the vehicle operation method. FIGS. 7 and 8 are diagrams illustrating a third example of the vehicle operation method. FIGS. 9 and 10 are diagrams illustrating a fourth example of the vehicle operation method. The left side of each figure is a schedule of each of vehicles 10 and 20, and the right side of each figure shows the movement of each of vehicles 10 and 20 on the single-lane line 2. Hereinafter, a premise in each example will be described.

In each example, the single-lane line 2 is a line connecting Station A and Station B. On the single-lane line 2, three stations, that is, Station X, Station Y, and Station Z are provided in this order between Station A and Station B. These three stations are stops 4 provided in the single-lane line 2. In order to simplify the description, the overtaking places provided on the single-lane line 2 are only three stops 4. Further, in each example, only one regular service vehicle 10 is operated between Station A and Station B at a time, and only one on-demand vehicle 20 is operated between Station A and Station B at a time.

In each example, it is assumed that the on-demand vehicle 20 travels in one direction and does not make a U-turn on the way. It is assumed that the on-demand vehicle 20 stops for a predetermined time at a pick-up point, that is, a place where the on-demand vehicle 20 picks up the user 40. Similarly, when the regular service vehicle 10 follows the regular operation schedule, it is assumed that the regular service vehicle 10 stops at the stop 4 for a predetermined time. In each example, it is assumed that the traveling speed of the on-demand vehicle 20 is higher than the traveling speed of the regular service vehicle 10.

### 3-2. First Example

In the first example shown in FIGS. 3 and 4, the regular service vehicle 10 is operated from Station B to Station A. In the regular operation schedule, the regular service vehicle 10 stops at all the stations that are stops 4 in order.

In the first example, after the regular service vehicle 10 leaves Station B, a dispatch request is input from the user 40 to the on-demand vehicle 20. The pick-up point desired by the user 40 is located between Station Y and Station Z. The user 40 wants to go from the pick-up point to Station B. Therefore, the on-demand vehicle 20 waiting at Station A is dispatched to the user 40.

The operation management server 100 that has received the dispatch request from the user 40 creates an operation schedule that allows the on-demand vehicle 20 to be dispatched to the user 40 in the shortest time. To create the operation schedule of the on-demand vehicle 20, the regular operation schedule of the regular service vehicle 10 is referred to. This is because there is a case where the on-demand vehicle 20 cannot be immediately started on the single-lane line 2 due to the relationship with the regular service vehicle 10. As illustrated in FIG. 3, even if the on-demand vehicle 20 is caused to depart immediately after receiving the dispatch request, the on-demand vehicle 20 comes across the regular service vehicle 10 traveling from Station Z on the way between Station Y and Station Z.

When the regular service vehicle 10 and the on-demand vehicle 20 are operated on the single-lane line 2, the operation of the regular service vehicle 10 having a large influence on the user should be prioritized. Therefore, the presence of the regular service vehicle 10 traveling on the single-lane line 2 at the same time may prevent the on-demand vehicle 20 from arriving at the location of the user 40 at the optimal time. The optimal time in the first example means the earliest time at which the on-demand vehicle 20 can be dispatched to the user 40 on the assumption that there is no other vehicle on the single-lane line 2.

In order to make the on-demand vehicle 20 arrive at the location of the user 40 at the optimal time, it is necessary to change the operation schedule of the regular service vehicle 10. Although the operation of the regular service vehicle 10 should be prioritized over the on-demand vehicle 20, there is an exception when there is no passenger on the regular service vehicle 10. If there is no passenger on the regular service vehicle 10, a delay due to a change in the operation schedule may be allowed.

Therefore, the operation management server 100 determines the presence or absence of a passenger of the regular service vehicle 10 in response to the prediction that the regular service vehicle 10 prevents the on-demand vehicle 20 from arriving at the location of the user 40 at the optimal time.

<Case where Passenger is on Regular Service Vehicle>

When the passenger 50 is on the regular service vehicle 10, the operation management server 100 operates the regular service vehicle 10 and the on-demand vehicle 20 by the operation method illustrated in FIG. 3. According to the operation method shown in FIG. 3, the regular service vehicle 10 is operated from Station B to Station A according to the regular operation schedule. The on-demand vehicle 20 does not depart from Station A immediately after receiving the dispatch request, but departs with a time delay from the dispatch request.

The regular service vehicle 10 operated according to the regular operation schedule stops at each station, and also stops at Station Y for a predetermined time. Station Y is the stop 4 located in the direction opposite to the traveling direction of the on-demand vehicle 20 with respect to the pick-up point at which the on-demand vehicle 20 picks up the user 40. At Station Y which is the stop 4, two vehicles can pass each other. The on-demand vehicle 20 departs from Station A so as to pass through Station Y while the regular service vehicle 10 is stopped at Station Y. That is, the operation management server 100 causes the on-demand vehicle 20 to pass the regular service vehicle 10 at Station Y.

The on-demand vehicle 20 passes the regular service vehicle 10 at Station Y and then arrives at the pick-up point. After picking up the user 40 at the pick-up point, the on-demand vehicle 20 is dispatched to Station B which is the destination. The arrival of the on-demand vehicle 20 with the user 40 at Station B is delayed by the waiting time from the reception of the dispatch request to the departure from Station A. However, according to the above operation method, it is possible to minimize the delay in arrival of the on-demand vehicle 20 with the user 40 at the destination without disturbing the operation of the regular service vehicle 10.

<Case where No Passenger is on Regular Service Vehicle>

When the passenger 50 is not on the regular service vehicle 10, the operation management server 100 operates the regular service vehicle 10 and the on-demand vehicle 20 by the operation method illustrated in FIG. 4. According to the operation method shown in FIG. 4, the on-demand vehicle 20 departs from Station A toward the pick-up point immediately after receiving the dispatch request. Then, after the user 40 is picked up at the pick-up point, the on-demand vehicle 20 departs toward Station B which is the destination. By operating the on-demand vehicle 20 in this way, it is possible to carry the user 40 of the on-demand vehicle 20 to the destination in the shortest time after receiving the dispatch request.

On the other hand, the regular service vehicle 10 is operated not according to the regular operation schedule but according to the temporary operation schedule created in accordance with the operation schedule of the on-demand vehicle 20. According to the regular operation schedule, the stop time at all stations including Station Z is set to a fixed time. However, according to the temporary operation schedule, after the regular service vehicle 10 is stopped at Station Z, the regular service vehicle 10 continues to be stopped beyond the predetermined stop time determined in the regular operation schedule. Station Z is the stop 4 located in the traveling direction of the on-demand vehicle 20 with respect to the pick-up point at which the on-demand vehicle 20 picks up the user 40. At Station Z which is the stop 4, two vehicles can pass each other. After the on-demand vehicle 20 that has picked up the user 40 at the pick-up point passes through Station Z, the regular service vehicle 10 departs from Station Z. By delaying the regular service vehicle 10 from the regular operation schedule in this way, it is possible to cause the on-demand vehicle 20 to arrive at the location of the user 40 at the optimal time.

The operation schedule of the regular service vehicle 10 after departing from Station Z differs depending on the presence or absence of users waiting at Station Y and Station X. It is necessary to stop the regular service vehicle 10 at the station where a passenger is waiting. However, if no user is waiting at a station, there is no need to stop the regular service vehicle 10 at the station. The operation management server 100 does not stop the regular service vehicle 10 at a stop where no user is waiting (a no-passenger stop), and allows the regular service vehicle 10 to pass through the no-passenger stop. In the example illustrated in FIG. 4, since Station Y and Station X are non-passenger stops where no user is waiting, the operation management server 100 causes the regular service vehicle 10 to pass through Station Y and Station X. By operating the regular service vehicle 10 in this way, it is possible to recover the time corresponding to the delay from the regular operation schedule.

### 3-3. Second Example

In the second example shown in FIGS. 5 and 6, the regular service vehicle 10 is operated from Station B to Station A. In the regular operation schedule, the regular service vehicle 10 stops at all the stations that are stops 4 in order.

In the second example, after the regular service vehicle 10 departs from Station B, a dispatch request in which a dispatch time is designated is input from the user 40 to the on-demand vehicle 20. The pick-up point desired by the user 40 is located between Station Y and Station Z. The user 40 wants to go from the pick-up point to Station B. Therefore, the on-demand vehicle 20 waiting at Station A is dispatched to the user 40.

The operation management server 100 that has received the dispatch request with the time designation from the user 40 creates an operation schedule for dispatching the on-demand vehicle 20 to the user 40 at a time as close to the optimal time as possible. The optimal time in the second example means a designated time at which the on-demand vehicle 20 is dispatched to the user 40.

When creating the operation schedule of each vehicle 10 and 20, the operation management server 100 determines whether or not the regular service vehicle 10 prevents the on-demand vehicle 20 from arriving at the location of the user 40 at the optimal time, similarly to the first example. In response to the prediction that the regular service vehicle 10 prevents the on-demand vehicle 20 from arriving at the location of the user 40 at the optimal time, the operation management server 100 determines the presence or absence of a passenger of the regular service vehicle 10.

<Case where Passenger is on Regular Service Vehicle>

When the passenger 50 is on the regular service vehicle 10, the operation management server 100 operates the regular service vehicle 10 and the on-demand vehicle 20 by the operation method illustrated in FIG. 5. According to the operation method shown in FIG. 5, the regular service vehicle 10 is operated from Station B to Station A according to the regular operation schedule.

The regular service vehicle 10 operated according to the regular operation schedule stops at each station, and also stops at Station Y for a predetermined time. The on-demand vehicle 20 departs from Station A so as to pass through Station Y while the regular service vehicle 10 is stopped at Station Y. That is, the operation management server 100 causes the on-demand vehicle 20 to pass the regular service vehicle 10 at Station Y.

The on-demand vehicle 20 passes the regular service vehicle 10 at Station Y and then arrives at the pickup point. After picking up the user 40 at the pick-up point, the on-demand vehicle 20 is dispatched to Station B which is the destination. In the example shown in FIG. 5, the arrival of the on-demand vehicle 20 at the location of the user 40 is later than the designated time.

The arrival of the on-demand vehicle 20 at the pickup point is, of course, preferably exactly at the designated time. However, it does not make sense to arrive earlier at the pick-up point with the reason that it cannot arrive exactly at the designated time. This is because the time during which the on-demand vehicle 20 can stop on the single-lane line 2 is limited because the regular service vehicle 10 comes. Therefore, when the on-demand vehicle 20 cannot arrive at the designated time, it is required to minimize the delay from the designated time while causing the user 40 to continuously wait for the arrival of the on-demand vehicle 20. According to the above operation method, the delay from the designated time designated by the user 40 can be minimized without interfering with the operation of the regular service vehicle 10.

<Case where No Passenger is on Regular Service Vehicle>

When the passenger 50 is not on the regular service vehicle 10, the operation management server 100 operates the regular service vehicle 10 and the on-demand vehicle 20 by the operation method illustrated in FIG. 6. According to the operation method shown in FIG. 6, the on-demand vehicle 20 departs from Station A so as to arrive at the pick-up point exactly at the designated time. Then, after the user 40 is picked up at the pickup point, the on-demand vehicle 20 departs toward Station B which is the destination.

On the other hand, the regular service vehicle 10 is operated not according to the regular operation schedule but according to the temporary operation schedule created in accordance with the operation schedule of the on-demand vehicle 20. According to the temporary operation schedule, after the regular service vehicle 10 is stopped at Station Z, the regular service vehicle 10 continues to be stopped beyond the predetermined stop time determined in the regular operation schedule. After the on-demand vehicle 20 that has picked up the user 40 at the pick-up point passes through Station Z, the regular service vehicle 10 departs from Station Z. By delaying the regular service vehicle 10 from the regular operation schedule in this way, it is possible to cause the on-demand vehicle 20 to arrive at the location of the user 40 at the designated time designated by the user 40.

Similarly to the first example, the operation schedule of the regular service vehicle 10 after departing from Station Z differs depending on the presence or absence of users waiting at Station Y and Station X. In the example illustrated in FIG. 6, since Station Y and Station X are non-passenger stops where no user is waiting, the operation management server 100 causes the regular service vehicle 10 to pass through Station Y and Station X. By operating the regular service vehicle 10 in this way, it is possible to recover the time corresponding to the delay from the regular operation schedule.

### 3-4. Third Example

In the third example shown in FIGS. 7 and 8, the regular service vehicle 10 is operated from Station B to Station A. In the regular operation schedule, the regular service vehicle 10 stops at all the stations that are stops 4 in order.

In the third example, after the regular service vehicle 10 leaves Station B, a dispatch request is input from the user 40 to the on-demand vehicle 20. The pick-up point desired by the user 40 is located between Station Y and Station Z. The user 40 wants to go from the pick-up point to Station A. Therefore, the on-demand vehicle 20 waiting at Station B is dispatched to the user 40. However, as illustrated in FIG. 7, even if the on-demand vehicle 20 is caused to depart immediately after receiving the dispatch request, the on-demand vehicle 20 catches up with the regular service vehicle 10 traveling ahead on the way between Station Y and Station Z. In a case where the on-demand vehicle 20 catches up with the regular service vehicle 10, the on-demand vehicle 20 has to follow the regular service vehicle 10 to an overtaking place where overtaking is possible.

Therefore, the operation management server 100 that has received the dispatch request from the user 40 creates an operation schedule for dispatching the on-demand vehicle 20 to the user 40 at a time as close to the optimal time as possible. The optimal time in the third example means the earliest time at which the on-demand vehicle 20 can be dispatched to the user 40 when it is assumed that there is no other vehicle on the single-lane line 2.

When creating the operation schedule of each vehicle 10 and 20, the operation management server 100 determines whether or not the regular service vehicle 10 prevents the on-demand vehicle 20 from arriving at the location of the user 40 at the optimal time, similarly to the first example. In response to the prediction that the regular service vehicle 10 prevents the on-demand vehicle 20 from arriving at the location of the user 40 at the optimal time, the operation management server 100 determines the presence or absence of a passenger of the regular service vehicle 10.

<Case where Passenger is on Regular Service Vehicle>

When the passenger 50 is on the regular service vehicle 10, the operation management server 100 operates the regular service vehicle 10 and the on-demand vehicle 20 by the operation method illustrated in FIG. 7. According to the operation method shown in FIG. 7, the regular service vehicle 10 is operated from Station B to Station A according to the regular operation schedule. The on-demand vehicle 20 does not depart from Station B immediately after receiving the dispatch request, but departs with a time delay from the dispatch request.

The regular service vehicle 10 operated according to the regular operation schedule stops at each station, and also stops at Station X for a predetermined time. Station X is the stop 4 located in the traveling direction of the on-demand vehicle 20 with respect to the pick-up point at which the on-demand vehicle 20 picks up the user 40. At Station X which is the stop 4, overtaking between vehicles is possible. After picking up the user 40 at the pick-up point, the on-demand vehicle 20 departs from Station B so as to pass through Station X while the regular service vehicle 10 is stopped at Station X. That is, the operation management server 100 causes the on-demand vehicle 20 to overtake the regular service vehicle 10 at Station X.

The on-demand vehicle 20 overtakes the regular service vehicle 10 at Station X and arrives at Station A earlier than the regular service vehicle 10. The arrival of the on-demand vehicle 20 with the user 40 at Station A is delayed by the waiting time from the reception of the dispatch request to the departure from Station B. However, according to the above operation method, it is possible to minimize the delay in arrival of the on-demand vehicle 20 with the user 40 at the destination without disturbing the operation of the regular service vehicle 10.

<Case where No Passenger is on Regular Service Vehicle>

When the passenger 50 is not on the regular service vehicle 10, the operation management server 100 operates the regular service vehicle 10 and the on-demand vehicle 20 by the operation method illustrated in FIG. 8. According to the operation method shown in FIG. 8, the on-demand vehicle 20 departs from Station B toward the pickup point immediately after receiving the dispatch request. Then, after the user 40 is picked up at the pick-up point, the on-demand vehicle 20 departs toward Station A which is the destination. By operating the on-demand vehicle 20 in this way, it is possible to carry the user 40 of the on-demand vehicle 20 to the destination in the shortest time after receiving the dispatch request.

On the other hand, the regular service vehicle 10 is operated not according to the regular operation schedule but according to the temporary operation schedule created in accordance with the operation schedule of the on-demand vehicle 20. According to the temporary operation schedule, after the regular service vehicle 10 is stopped at Station Z, the regular service vehicle 10 continues to be stopped beyond the predetermined stop time determined in the regular operation schedule. Station Z is the stop 4 located in the direction opposite to the traveling direction of the on-demand vehicle 20 with respect to the pickup point at which the on-demand vehicle 20 picks up the user 40.

The delay time with respect to the departure time from Station Z determined in the regular operation schedule includes the time required for the on-demand vehicle 20 that has passed through Station Z to pick up the user 40 at the pick-up point. Further, the delay time with respect to the departure time from Station Z includes the time from when the on-demand vehicle 20 departs from the pick-up point to when the regular service vehicle 10 passes through the pick-up point, that is, a margin time for safety. By delaying the regular service vehicle 10 from the regular operation schedule in this way, it is possible to cause the on-demand vehicle 20 to arrive at the location of the user 40 at the optimal time.

Similarly to the first example, the operation schedule of the regular service vehicle 10 after departing from Station Z differs depending on the presence or absence of users waiting at Station Y and Station X. In the example illustrated in FIG. 8, since Station Y and Station X are non-passenger stops where no user is waiting, the operation management server 100 causes the regular service vehicle 10 to pass through Station Y and Station X. By operating the regular service vehicle 10 in this way, it is possible to recover the time corresponding to the delay from the regular operation schedule.

### 3-5. Fourth Example

In the fourth example shown in FIGS. 9 and 10, the regular service vehicle 10 is operated from Station B to Station A. In the regular operation schedule, the regular service vehicle 10 stops at all the stations that are stops 4 in order.

In the fourth example, after the regular service vehicle 10 departs from Station B, a dispatch request in which a dispatch time is designated is input from the user 40 to the on-demand vehicle 20. The pick-up point desired by the user 40 is located between Station Y and Station Z. The user 40 wants to go from the pick-up point to Station A. Therefore, the on-demand vehicle 20 waiting at Station B is dispatched to the user 40.

The operation management server 100 that has received the dispatch request with the time designation from the user 40 creates an operation schedule for dispatching the on-demand vehicle 20 to the user 40 at a time as close to the optimal time as possible. The optimal time in the fourth example means a designated time at which the on-demand vehicle 20 is dispatched to the user 40.

When creating the operation schedule of each vehicle 10 and 20, the operation management server 100 determines whether or not the regular service vehicle 10 prevents the on-demand vehicle 20 from arriving at the location of the user 40 at the optimal time, similarly to the first example. In response to the prediction that the regular service vehicle 10 prevents the on-demand vehicle 20 from arriving at the location of the user 40 at the optimal time, the operation management server 100 determines the presence or absence of a passenger of the regular service vehicle 10.

<Case where Passenger is on Regular Service Vehicle>

When the passenger 50 is on the regular service vehicle 10, the operation management server 100 operates the regular service vehicle 10 and the on-demand vehicle 20 by the operation method illustrated in FIG. 9. According to the operation method shown in FIG. 9, the regular service vehicle 10 is operated from Station B to Station A according to the regular operation schedule.

The regular service vehicle 10 operated according to the regular operation schedule stops at each station, and also stops at Station X for a predetermined time. After picking up the user 40 at the pick-up point, the on-demand vehicle 20 departs from Station B so as to pass through Station X while the regular service vehicle 10 is stopped at Station X. That is, the operation management server 100 causes the on-demand vehicle 20 to overtake the regular service vehicle 10 at Station X.

In the example shown in FIG. 9, the arrival of the on-demand vehicle 20 at the location of the user 40 is later than the designated time. This is because overtaking the regular service vehicle 10 stopped at Station X is a constraint condition in determining the operation schedule of the on-demand vehicle 20. However, according to the above-described operation method, the delay from the designated time designated by the user 40 can be minimized without disturbing the operation of the regular service vehicle 10.

<Case where No Passenger is on Regular Service Vehicle>

When the passenger 50 is not on the regular service vehicle 10, the operation management server 100 operates the regular service vehicle 10 and the on-demand vehicle 20 by the operation method illustrated in FIG. 10. According to the operation method shown in FIG. 10, the on-demand vehicle 20 departs from Station B so as to arrive at the pick-up point exactly at the designated time. Then, after the user 40 is picked up at the pick-up point, the on-demand vehicle 20 departs toward Station A which is the destination.

On the other hand, the regular service vehicle 10 is operated not according to the regular operation schedule but according to the temporary operation schedule created in accordance with the operation schedule of the on-demand vehicle 20. According to the temporary operation schedule, after the regular service vehicle 10 is stopped at Station Z, the regular service vehicle 10 continues to be stopped beyond the predetermined stop time determined in the regular operation schedule. The delay time with respect to the departure time from Station Z determined in the regular operation schedule includes the time required for the on-demand vehicle 20 that has passed through Station Z to pick up the user 40 at the pick-up point. Further, the delay time with respect to the departure time from Station Z includes the margin time from when the on-demand vehicle 20 departs from the pick-up point to when the regular service vehicle 10 passes through the pick-up point. By delaying the regular service vehicle 10 from the regular operation schedule in this way, it is possible to cause the on-demand vehicle 20 to arrive at the location of the user 40 at the designated time designated by the user 40.

Similarly to the first example, the operation schedule of the regular service vehicle 10 after departing from Station Z differs depending on the presence or absence of users waiting at Station Y and Station X. In the example illustrated in FIG. 10, since Station Y and Station X are non-passenger stops where no user is waiting, the operation management server 100 causes the regular service vehicle 10 to pass through Station Y and Station X. By operating the regular service vehicle 10 in this way, it is possible to recover the time corresponding to the delay from the regular operation schedule.

### 3-6. Effect

In the above-described four specific examples, when it is predicted that the regular service vehicle 10 prevents the on-demand vehicle 20 from arriving at the location of the user 40 at the optimal time, different processing is performed depending on whether or not a passenger is on the regular service vehicle 10. When a passenger is on the regular service vehicle 10, the arrival time of the on-demand vehicle 20 at the location of the user 40 is delayed from the optimal time, and the regular service vehicle 10 is caused to travel according to the regular operation schedule. However, when no passenger is on the regular service vehicle 10, the on-demand vehicle 20 is caused to arrive at the location of the user 40 at the optimal time even if the regular service vehicle 10 is delayed from the regular operation schedule. As described above, by changing the operation schedule of the regular service vehicle 10 according to the presence or absence of the passenger of the regular service vehicle 10, it is possible to improve convenience for the user 40 of the on-demand vehicle 20 while giving priority to the passenger of the regular service vehicle 10.

### 4. Others

In the four specific examples of the above embodiment, all the overtaking places are stops, but overtaking places other than stops may be included. However, a stop is preferable as a place where the regular service vehicle 10 waits for the on-demand vehicle 20 to pass by. This is because there is a possibility that a passenger gets on the stopped regular service vehicle 10. On the other hand, when the on-demand vehicle 20 waits for the regular service vehicle 10 to pass by, the on-demand vehicle 20 may wait at any overtaking place including a stop.

In each of the first to fourth examples, when no passenger is on the regular service vehicle 10, the regular service vehicle 10 may be stopped at the overtaking place to wait for the on-demand vehicle 20 to pass, and then the regular operation regular service vehicle 10 may be operated at a speed higher than the traveling speed defined in the regular operation schedule. In addition to increasing the traveling speed of the regular service vehicle 10, the regular service vehicle 10 may be allowed to pass through a non-passenger stop where there is no passenger among stops where the regular service vehicle 10 is to stop in the regular operation schedule.

The on-demand vehicle 20 may be used not only for the user 40 who makes a reservation but also as a vehicle for ride-sharing.

At least one of the autonomous driving ECU 12 of the regular service vehicle 10 and the autonomous driving ECU 22 of the on-demand vehicle 20 may be included as a component of the operation system. In this case, the at least one processor means the processor 110 of the operation management server 100 and the processor of the autonomous driving ECU 12 or the autonomous driving ECU 22. In this case, the plurality of instructions means instructions stored in the program memory 120 of the operation management server 100 and instructions stored in the program memory of the autonomous driving ECU 12 or the autonomous driving ECU 22.

What is claimed is:

1. A method for operating a regular service vehicle and an on-demand vehicle that travel by autonomous driving on a single lane having a plurality of overtaking places including a stop, the method comprising:
predicting the on-demand vehicle being prevented from arriving at a location of a user of the on-demand vehicle at an optimal time by the regular service vehicle;
when a passenger is on the regular service vehicle, delaying an arrival time of the on-demand vehicle at the location of the user from the optimal time to cause the regular service vehicle to travel according to a regular operation schedule; and
when no passenger is on the regular service vehicle, delaying the regular service vehicle from the regular operation schedule to cause the on-demand vehicle to arrive at the location of the user at the optimal time.

2. The method according to claim 1, further comprising
when no passenger is on the regular service vehicle, causing the regular service vehicle to pass through a no-passenger stop among stops at which the regular service vehicle is scheduled to stop in the regular operation schedule after delaying the regular service vehicle from the regular operation schedule.

3. The method according to claim 1, further comprising
when no passenger is on the regular service vehicle, operating the regular service vehicle at a speed higher than a traveling speed defined in the regular operation schedule so as to recover a delay from the regular operation schedule after delaying the regular service vehicle from the regular operation schedule.

4. The method according to claim 1, further comprising:
causing the on-demand vehicle to travel to face the regular service vehicle;
when a passenger is on the regular service vehicle, causing the on-demand vehicle to pass the regular service vehicle at a stop located in a direction opposite to a traveling direction of the on-demand vehicle with respect to a pick-up point where the on-demand vehicle picks up the user; and
when no passenger is on the regular service vehicle, causing the regular service vehicle to wait at an overtaking place located in a traveling direction of the on-demand vehicle with respect to the pick-up point until the on-demand vehicle passes through the overtaking place.

5. The method according to claim 1, further comprising:
causing the on-demand vehicle to travel to overtake the regular service vehicle;
when a passenger is on the regular service vehicle, causing the on-demand vehicle to overtake the regular service vehicle at a stop located in a traveling direction of the on-demand vehicle with respect to a pick-up point where the on-demand vehicle picks up the user; and
when no passenger is on the regular service vehicle, causing the regular service vehicle to wait at an overtaking place located in a direction opposite to a traveling direction of the on-demand vehicle with respect to the pick-up point until the on-demand vehicle passes through the overtaking place.

6. The method according to claim 1, wherein
the optimal time is an earliest time at which the on-demand vehicle is dispatched to the user on an assumption that there is no other vehicle in the single lane.

7. The method according to claim 1, wherein
the optimal time is a designated time of dispatching the on-demand vehicle to the user.

8. A system for operating a regular service vehicle and an on-demand vehicle that travel by autonomous driving on a single lane having a plurality of overtaking places including a stop, the system comprising:
at least one processor; and
a program memory coupled to the at least one processor and storing a plurality of executable instructions configured to cause the at least one processor to:
predict the on-demand vehicle being prevented from arriving at a location of a user of the on-demand vehicle at an optimal time by the regular service vehicle;
when a passenger is on the regular service vehicle, delay an arrival time of the on-demand vehicle at the location of the user from the optimal time to cause the regular service vehicle to travel according to a regular operation schedule; and
when no passenger is on the regular service vehicle, delay the regular service vehicle from the regular operation schedule to cause the on-demand vehicle to arrive at the location of the user at the optimal time.

9. The system according to claim 8, wherein the plurality of executable instructions is configured to further cause the at least one processor to
when no passenger is on the regular service vehicle, cause the regular service vehicle to pass through a no-passenger stop among stops at which the regular service vehicle is scheduled to stop in the regular operation schedule after delaying the regular service vehicle from the regular operation schedule.

10. The system according to claim 8, wherein the plurality of executable instructions is configured to further cause the at least one processor to
when no passenger is on the regular service vehicle, operate the regular service vehicle at a speed higher than a traveling speed defined in the regular operation schedule so as to recover a delay from the regular operation schedule after delaying the regular service vehicle from the regular operation schedule.

11. The system according to claim 8, wherein the plurality of executable instructions is configured to further cause the at least one processor to:
cause the on-demand vehicle to travel to face the regular service vehicle;
when a passenger is on the regular service vehicle, cause the on-demand vehicle to pass the regular service vehicle at a stop located in a direction opposite to a traveling direction of the on-demand vehicle with respect to a pick-up point where the on-demand vehicle picks up the user; and
when no passenger is on the regular service vehicle, cause the regular service vehicle to wait at an overtaking place located in a traveling direction of the on-demand vehicle with respect to the pick-up point until the on-demand vehicle passes through the overtaking place.

12. The system according to claim 8, wherein the plurality of executable instructions is configured to further cause the at least one processor to:
cause the on-demand vehicle to travel to overtake the regular service vehicle;
when a passenger is on the regular service vehicle, cause the on-demand vehicle to overtake the regular service vehicle at a stop located in a traveling direction of the on-demand vehicle with respect to a pick-up point where the on-demand vehicle picks up the user; and
when no passenger is on the regular service vehicle, cause the regular service vehicle to wait at an overtaking place located in a direction opposite to a traveling direction of the on-demand vehicle with respect to the pick-up point until the on-demand vehicle passes through the overtaking place.

13. The system according to claim 8, wherein
the optimal time is an earliest time at which the on-demand vehicle is dispatched to the user on an assumption that there is no other vehicle in the single lane.

14. The system according to claim 8, wherein
the optimal time is a designated time of dispatching the on-demand vehicle to the user.
